(19) United States
(12) Patent Application Publication
(10) Pub. No.: US 2017/0264118 A1
(43) Pub. Date: Sep. 14, 2017

(54) COMBINATION PORTABLE POWER CHARGER AND COMPACT MIRROR

(71) Applicant: Halo2Cloud LLC, Hartford, CT (US)

(72) Inventors: Garold C. Miller, Hartford, CT (US); Nathan Daniel Weinstein, Hartford, CT (US)

(21) Appl. No.: 15/449,152

(22) Filed: Mar. 3, 2017

Related U.S. Application Data
(60) Provisional application No. 62/307,158, filed on Mar. 11, 2016.

(51) Int. Cl. H02J 7/00; A45D 42/02; F21L 4/08; F21V 23/04; F21L 4/02

(52) U.S. Cl. CPC H02J 7/0044; F21V 23/0414; H02J 7/0047; F21L 4/02; F21L 4/08; A45D 42/02; H02J 2007/005; H02J 2007/0049; F21Y 2115/10

(57) ABSTRACT

A portable power charger is combined with a personalized accessory, namely, a compact mirror with a lighting feature, to improve the functionality of the portable charger. The charger includes a charger housing with a cover pivotally hinged thereto and moveable between a closed condition and an opened condition. When the cover is opened, it exposes at least one mirror disposed in either the top surface of the charger housing or the inward face of the cover as well as at least one LED light that preferably automatically turns on when the cover is opened. At least one power connection interface is provided on the charger housing for connecting the charger with an external power source for recharging an internal rechargeable battery of the charger or with an electronic device in need of recharging form the internal rechargeable battery of the portable charger. Additional connection interfaces are provided as necessary.

### CROSS-REFERENCE TO RELATED APPLICATION

This application claims the benefit of U.S. Provisional Patent Application No. 62/307,158, filed Mar. 11, 2016, the contents of which are incorporated herein by reference in their entirety.

### FIELD OF INVENTION

The present invention generally relates to power chargers for electronic devices, and more particularly relates to a decorative portable power charger that can be combined with and used as a personalized accessory, such as a compact mirror, having multiple features that improve upon its use and functionality.

### BACKGROUND OF THE INVENTION

Present day consumers typically own several electronic devices specifically designed for portability and use on-the-go, including, for example, a mobile phone or smart phone, a portable music player like an iPod® or an MP3 player, a tablet, a portable gaming unit, and the like. Each of these devices requires frequent recharging. Such electronic devices typically require connection to an external power source, such as a wall outlet, a car charger, an airplane charger, or a computer, for recharging. However, many times, such a power source is not readily available or close by, and the electronic device has insufficient charge remaining before the user can get to a power source to connect the device. Moreover, even when the device is connected to an external power source for recharging, it is difficult to continue using the device, as the device needs to remain tethered to the power source.

Similarly, a separate charging cable is usually required for connecting an electronic device with a particular power source. For example, a consumer will have one cable for charging a phone at home with an AC wall socket, and another cable for charging the phone in the car using the DC car charging socket, and perhaps additional cables for charging the phone using a computer or on an airplane. Moreover, different electronic devices often utilize different connection ports and interfaces such that a single charging cable is not compatible with multiple devices. Accordingly, a tech-savvy consumer, with several electronic devices, will usually have multiple charging cables to keep track of. Even then, the consumer may not always be in a place where a power source is readily available, for example, if they are at the park, or may not have the appropriate cable or adapter available to use with a particular power source, for example, they are in the office but left their charging cable at home, or may be without sufficient power to recharge a phone or other device due to bad weather or a power outage.

On occasion, an electronic device needs a small amount of charge to finish a task before the device powers down due to insufficient battery capacity. For example, a user on a call using a mobile phone may wish to finish the call, but cannot find a power source to plug into, may not have enough time to get to a power source, or may not have the appropriate charging cable with her at the time. As noted, if the phone is plugged into a traditional power source, like a wall socket, it is difficult to continue using the phone as desired, and the user must wait by the wall socket for the device to charge. Accordingly, what is needed is a power charger, even with a small boost of power, that is as portable as the electronic device and preferably easy to carry with the electronic device, and thus easily usable on-the-go.

Further, portable power chargers designed for use on-the-go must be suitable to a variety of conditions, as they are often most in need where a standard external power source is not available, and thus often needed when there is no power at all. For example, a portable power charger is especially useful when walking, camping, at the park, at the mall, or at a sporting event, where one may need to use a phone in an emergency situation. On occasion, it may be dark when the charger is needed, and thus there is insufficient ambient light to assist in use of the charger or the electronic device needed a power boost. Accordingly, there is a need for a portable charger with the versatility of providing a light to assist in use of the power charger to connect to an electronic device needing a charge, or simply as a flashlight to help the user in a time of need even when the power charger is not yet needed.

Still further, even portable power chargers often use up valuable storage space, such as in a bag or a purse, adding one more thing a consumer needs to carry around. For example, a consumer may need to carry and account for multiple electronic devices, along with a wallet, keys, perhaps make-up, and various other objects, such that adding a portable power charger may simply add to the load. Accordingly, there is a need for a portable charger that is not only easy to use and find, but which can be combined with other objects a consumer may need in order to reduce the load and congestion in a bag or purse. In this regard, the charger does not take up additional space in one's pocket or purse, can provide multiple functions, and is readily accessible whenever needed, especially for that small boost of power to continue an activity on an electronic device in a time of need. Additionally, such a portable charger can be a fashionable and functional accessory providing functional assistance to recharge various portable electronic devices.

Additionally, such portable charger devices typically require a dedicated input port for recharging the internal battery and a separate output port dedicated for recharging electrical devices from the internal battery. More particularly, such charging devices often require multiple output ports for recharging multiple electronic devices at the same time. The addition of extra charging ports compromises the size and design of the charger unit, for example, a unit with a dedicated input port and two or more output ports would need to be larger than a charger unit with just a single port due to the need to properly arrange the electronics for operation of the charger as desired.

In view of the foregoing, there is a need for a charger that can be used to charge a variety of electronic devices, including but not limited to smart phones, mobile phones, data tablets, music players, cameras, camcorders, gaming units, e-books, Bluetooth® headsets and earpieces, GPS devices, and the like, either individually or collectively in various combinations. Additionally, there is a need for such a charger that is portable, has a compact size, and is easy to use in various conditions and locations to charge one or more electronic devices simultaneously, including but not limited to in a house or office, a car or an airplane. Still further, there is a need for a portable charger having a port or power connector that can act both as an input for recharging an internal battery unit in the charger and as an output for recharging an electronic device connected to the charger. Still further, there is a need for a portable charger that can recharge the internal battery from an external power source at the same time as an electronic device connected to the charger, even while both the external power source and the electronic device are connected to the charger through the same port. Still further, there is a need for a portable charger unit in a compact size that has increased functionality for a user requiring a portable source of power, for example, by incorporating the charger into a personalized accessory, such as a compact mirror. Accordingly, it is a general object of the present invention to provide a portable charger that improves upon conventional power chargers currently on the market and that overcomes the problems and drawbacks associated with such prior art chargers.

### SUMMARY OF THE INVENTION

In accordance with the present invention, a compact, decorative and multi-functional portable charger is provided for charging an electronic device on-the-go. In general, a portable charger unit may comprise a portable charger housing having an internal rechargeable battery unit for connecting to and recharging one or more electronic device, as necessary, and a power connection female port and/or a power connection male interface for connecting the charger unit with at least one electronic device, or an external power source, or both. Additionally, in the present invention, the portable charger housing is combined with a personalized accessory, such as a compact mirror assembly including one or more mirrors, and other features improving upon the functionality of the portable power charger. In this regard, the user can maximize her storage space in a purse, bag or pocket by combining devices, namely a portable power charger and a compact mirror, into a single device for easy transportation, use and storage.

In a first aspect of the present invention, a combination portable power charger and compact mirror comprises a charger housing internally storing a rechargeable battery and a power connection interface operatively connected to the internal battery and capable of acting as a power input and a power output depending on what is connected to the power connection interface. A cover is pivotally connected to the charger housing and movable between a closed condition and an opened condition. At least one LED light is disposed in either the charger housing or the cover, with a first mirror and a second mirror respectively positioned within the charger housing and an inward facing surface of the cover such that the first mirror and the second mirror face one another when the cover is in its closed condition.

In a second aspect of the present invention, a combination portable power charger and compact mirror comprises a charger housing internally storing a rechargeable battery and a power connection port operatively connected to the internal battery and capable of acting as at least one of (i) a power input for providing an electrical charge to the rechargeable battery when the portable charger and compact mirror is connected to an external power source, and (ii) a power output for charging an electronic device when said device is connected to the portable charger and compact mirror via the power connection port. A cover is pivotally connected to the charger housing and movable between a closed condition and an opened condition. At least one LED light is disposed in either the charger housing or the cover, wherein the at least one LED light automatically turns on when the cover is picoted away from its closed condition. A first mirror is disposed in one of an inward facing surface of the cover or the top surface of the charger housing for providing a reflective surface when the cover is in its opened condition.

In a third aspect of the present invention, a combination portable power charger and compact mirror comprises a charger housing internally storing a rechargeable battery, a power connection input port operatively connected to the internal battery for providing an electrical charge to the rechargeable battery when the portable charger and compact mirror is connected to an external power source, and a power connection output port for charging an electronic device when said device is connected to the portable charger and compact mirror via the power connection port. A cover is pivotally connected to the charger housing and movable between a closed condition and an opened condition. At least one LED light is disposed in either the charger housing or the cover, wherein the at least one LED light automatically turns on when the cover is pivoted away from its closed condition. A first mirror is disposed in one of an inward facing surface of the cover or the top surface of the charger housing for providing a reflective surface when the cover is in its opened condition.

In embodiments of the present invention, the combination portable charger and compact mirror can further include a charging cable retractably connected to the charger housing and operatively connected to the internal battery. The charging cable is preferably storable within the general footprint of the charger housing.

These and other objects, features and advantages of the present invention will become apparent in light of the detailed description of embodiments thereof, as illustrated in the accompanying drawings.

### BRIEF DESCRIPTION OF THE DRAWINGS

FIG. 1 shows a perspective view of a combination portable power charger and compact mirror with a cover in an open position in accordance with the present invention.

FIG. 2 shows a perspective view of the portable charger of FIG. 1 with the cover in a closed position.

FIG. 3 shows a top planar view of the portable charger of FIG. 1 with the cover removed.

FIG. 4 shows a front planar view of the portable charger of FIG. 2 with the cover in a closed position.

FIG. 5 shows a left-hand side planar view of the portable charger of FIG. 2 with the cover in a closed position.

FIG. 6 shows a right-hand side planar view of the portable charger of FIG. 2 with the cover in a closed position.

FIG. 7 shows a top planar view of the portable charger of FIG. 1 with the cover in an open position, in accordance with an embodiment of the present invention.

FIG. 8 shows a back planar view of the portable charger of FIG. 2 with the cover in a closed position.

FIG. 9 shows a bottom planar view of the portable charger of FIG. 1 with a cut-away view showing a retractable cable extending from the portable charger in accordance with an embodiment of the present invention.

FIG. 10 is a flowchart illustrating the operation of a combination portable power charger and compact mirror in accordance with the present invention when connected to an external power source and/or at least one electronic device.

FIG. 11 shows a circuit diagram within the portable charger of FIG. 1.

### DETAILED DESCRIPTION OF PREFERRED EMBODIMENTS

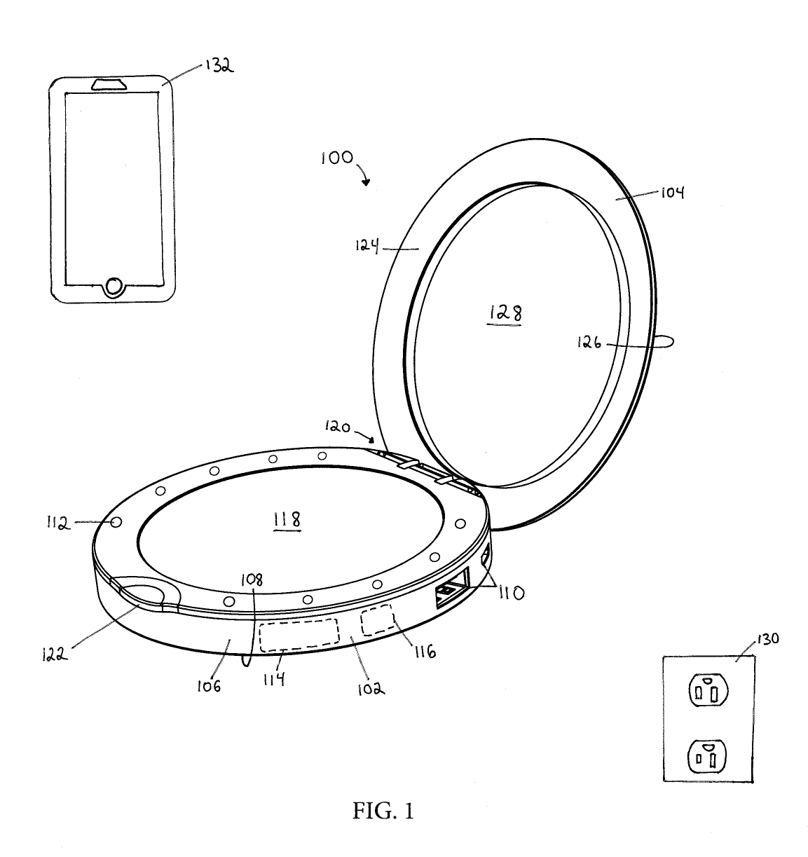

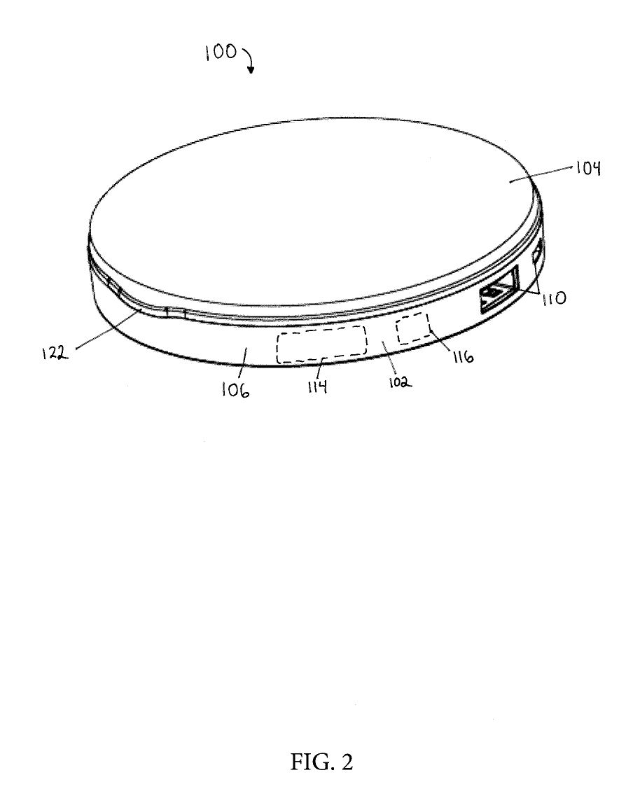

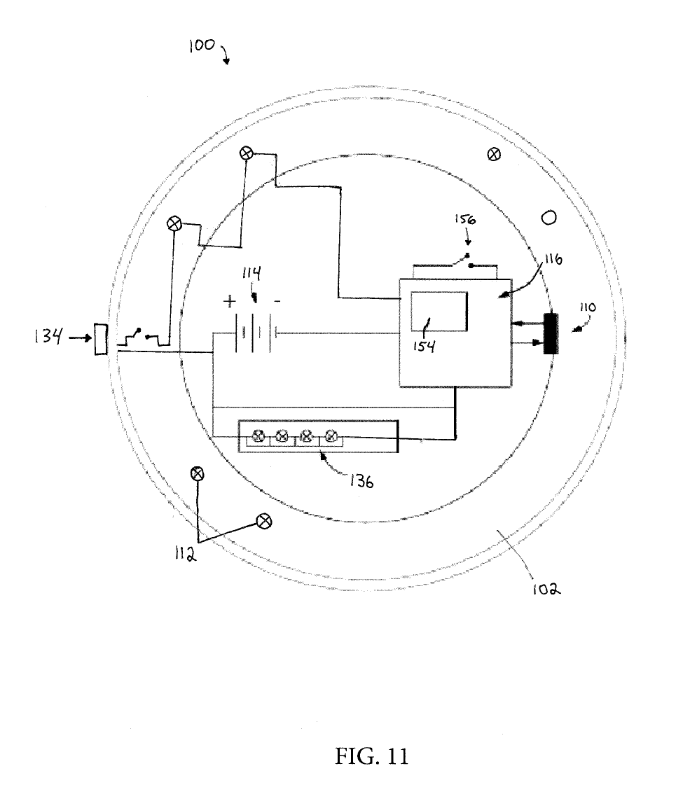

A combination portable power charger and compact mirror in accordance with an embodiment of the present invention, is generally designated as reference numeral 100 and shown in perspective view in FIGS. 1-2. The portable charger 100 generally includes a rechargeable internal battery unit 114, illustrated in FIG. 11, disposed within a charger housing 102. As illustrated in FIG. 1, the portable charger 100 generally takes the form of a compact mirror, and in this regard, includes a generally elliptical-shaped cover 104 attached to the charger housing 102 by a hinge 120 for covering the charger housing 102 and enclosing one or more mirrors and lighting features, as illustrated. In FIG. 1, the cover 104 is shown in an opened condition. FIG. 2 illustrates the portable charger 100 with the cover 104 closed.

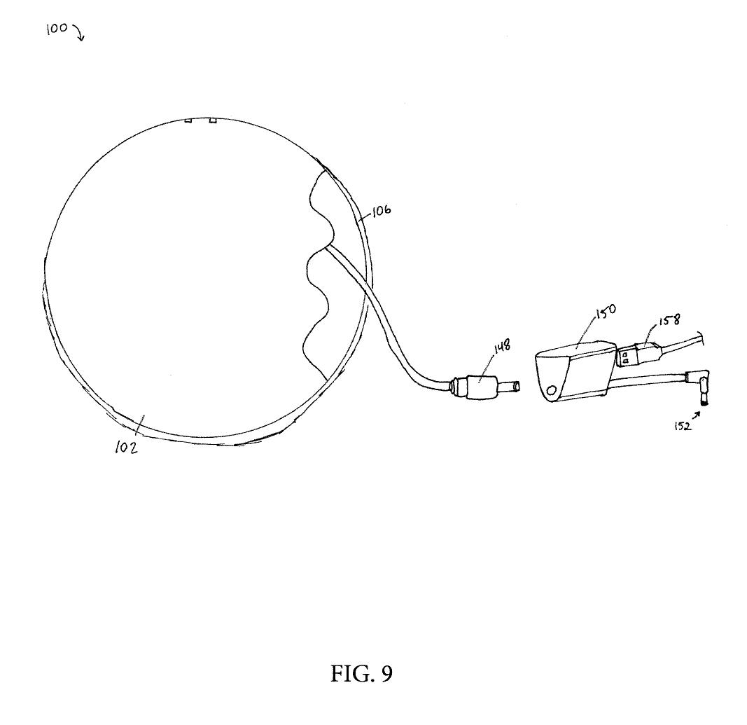

Referring generally to FIG. 1, the charger housing 102 includes a side wall 106 extending from a base surface 108 and defining the shape of the charger housing 102 as well as the interior volume in which the internal battery unit 114 is stored. Formed within the side wall 106 can be one or more power connection interfaces 110 that can operate as either a power input or a power output, or both. The power connection interfaces 110 may, for example, be a power connection female port (as illustrated in FIG. 1) or a power connection male interface (as illustrated in FIG. 9). Further, embodiments of the present invention may use a combination of female ports and male interfaces to connect the power charger 100 with electronic devices in need of a charge and/or an external power source in order to recharge the portable charger 100 itself. Regardless of form, the power connection interfaces are operatively connected to the internal battery unit 114

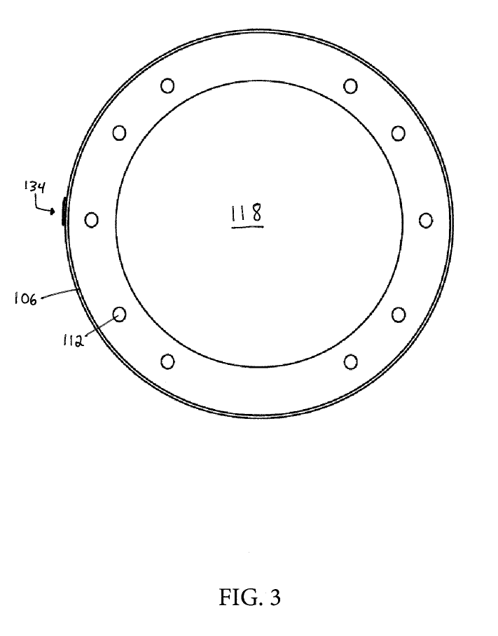

The charger housing 102 further includes at least one light 112 powered from the internal battery unit 114, and a controller unit 116 for controlling operation of the at least one light 112 via the internal battery unit 114. The light(s) 112, which may be Light Emitting Diode (“LED”) lights, preferably surround or are positioned relative to a mirror 118 disposed on top surface of or recessed within the charger housing 102, as illustrated in FIG. 3. The light(s) 112 may automatically illuminate when the cover 104 transitions from a closed position (shown in FIG. 2) to an open position (shown in FIG. 1). For example, a circuit may be completed when the cover 104 contacts the side wall 106 in an open position, or alternately based on the pivoted position of the cover 104. It is also contemplated that the cover 104, when in a closed position, biases an electrical circuit in an open position, and that the circuit is completed when the cover 104 is pivoted away from the charger housing 102, illuminating the light(s) 112.

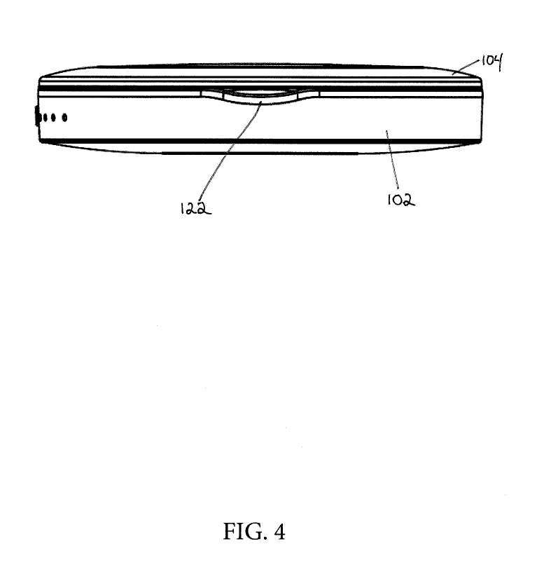

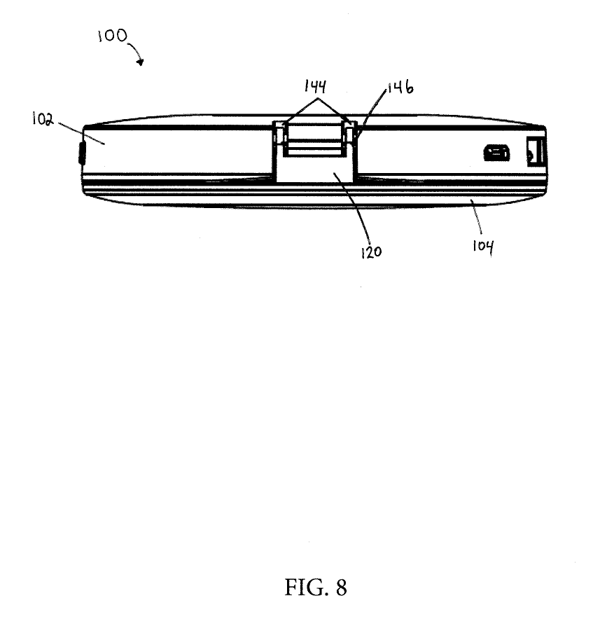

The charger housing 102 and cover 104 are pivotally connected via a hinge 120, as shown in FIG. 8. Referring to FIG. 4, the charger housing 102 further includes a protrusion 122 on the front of the housing 102 forming or defining a recessed groove or notch relative to the cover 104 to allow a user to separate the cover 104 from the charger housing 102 using his/her fingers to open the cover 104.

Still referring to FIG. 1, the cover 104 includes an inward facing surface 124 and an outward facing surface 126. In a closed position, the cover may be partially recessed or flush relative to the charger housing 102 with the side wall 106 either extending past the cover 104 or being flush with the cover 104. In embodiments of the present invention, the cover 104 may extend slightly past the side wall 106 of the charger housing 102 when in a closed position, again enabling opening of the cover 104 by a user's fingers.

In the illustrated embodiment, a second mirror 128 is disposed within the inward facing surface 124 of the cover 104 for providing a reflective surface. In embodiments, one mirror 118 is a distortion free reflective surface and the other mirror 128 is a close-up magnified mirror, such as a three times magnification reflective surface. It is understood that the mirrors 118, 128 are interchangeable and both mirrors 118, 128 may be of the same type without departing from the spirit and principles of the present invention.

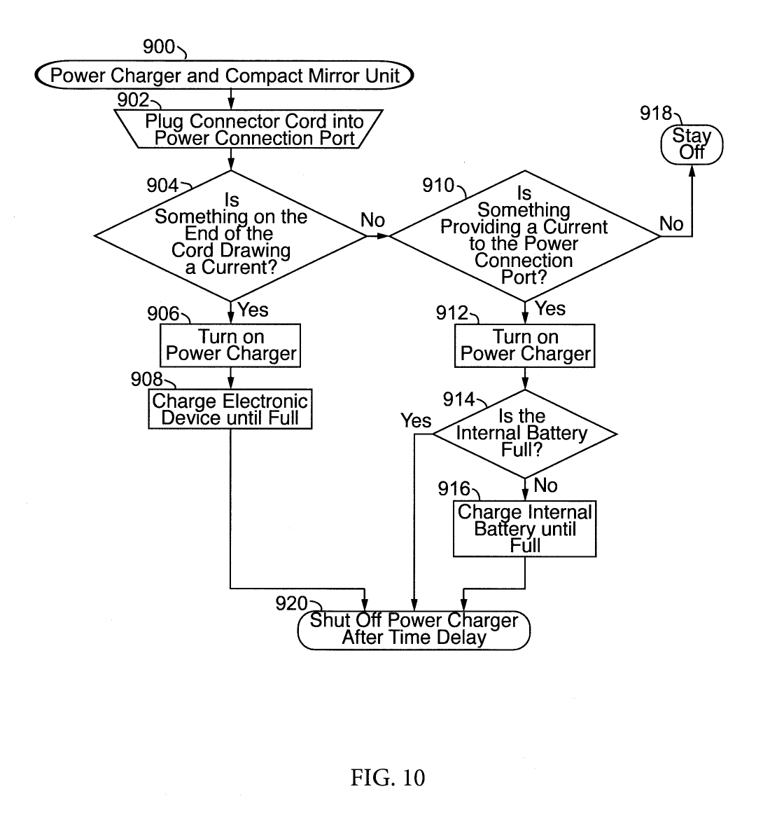

As noted, the power connection ports 110 are operatively connected with the internal rechargeable battery unit 114 to supply a standard charging power profile, such as a USB 2.0 standard 2A at +5 VDC, when acting as a power output port. When acting as a power input port, the one or more power connection ports 110 supply an electrical charge from an external power source 130 (such as a wall socket as illustrated in FIG. 1) for recharging the internal battery unit 114. The controller unit 116 determines which operational mode the power connection port 110 is in based on what is connected to the port. Further discussion of the operational logic of the controller unit 116 is described with regards to FIG. 10. Additionally, the power connection port(s) 110 can be USB, mini-USB, or micro-USB type ports, or any other known connection interface, for connecting the internal rechargeable battery unit 114 with at least one electronic device 132, or the external power source 130, or both.

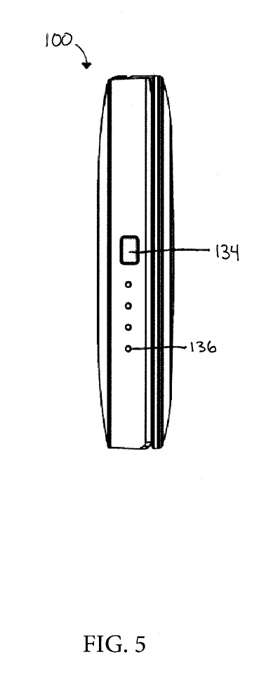

Referring to FIG. 5, an external manual switch 134 for controlling operation of the lights 112 is disposed on the side wall 106. The switch 134 is operatively connected with the lights 112 via the controller unit 116 and internal battery unit 114 (as shown in FIG. 11).

The switch 134 may be used in addition to or in lieu of the automatic illumination protocol described earlier. For example, the light(s) 112 may automatically illuminate when the cover 104 pivots away from the charger housing 102 to its opened position, and the external switch 134 can then be used to dim or further brighten the light(s) 112, or alternatively, manually turn off the light(s) 112 if not needed so as to preserve battery life. In embodiments, the external switch 134 can be, for example, a slideable dimmer switch allowing for independent adjustment of the brightness of the LED light(s) 112. It is also contemplated that the brightness of the LED light(s) 112 can be adjusted by the number of times the switch 134 is depressed and/or the force applied to the switch 134. As noted, in some embodiments, the switch 134 can be used to manually turn the light(s) 112 on or off.

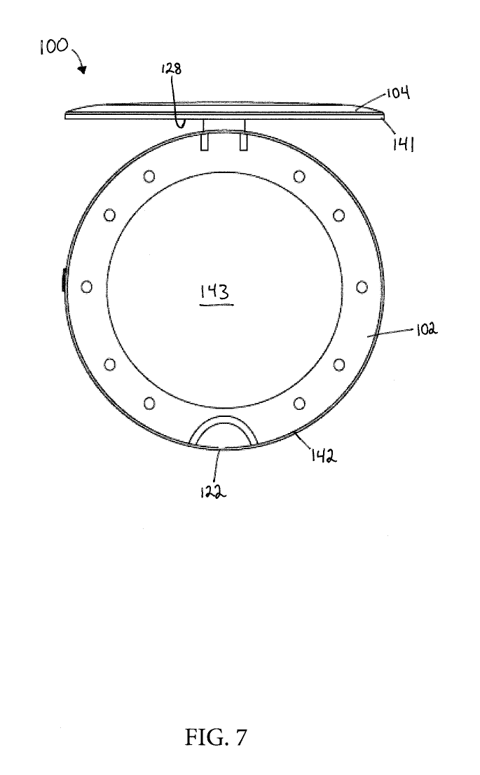

In addition to the at least one light 112 being disposed within the charger housing 102, as shown in FIGS. 3 and 7, the light(s) 112, or additional lights, may also be disposed within the cover inward facing surface 124 or the outward facing surface 126 and can light up to (i) facilitate use of the combination portable power charger and compact mirror unit 100, (ii) locate the external power source 130, and (iii) act as a flashlight to find the at least one electronic device 132 and/or other items for example, inside a purse of a bag.

Referring to FIGS. 2 and 4-6, the combination portable power charger and compact mirror unit 100 is illustrated in a closed position. When so closed, the charger unit 100 presents a compact and easily portable source of power for electronic devices that can be used on-the-go when a standard power source is not readily available. By combining the charger with a personalized accessory, such as a compact mirror and a lighting feature as shown and described herein, the functionality of the charger unit 100 is increased for the user.

The charger housing 102 includes at least one LED battery indicator light 136 disposed on the side wall 106 that is adapted to indicate the amount of charge of the internal battery unit 114 and/or the at least one electronic device 132. While the internal battery unit 114 is charging, the LED battery indicator light(s) 136 can turn on and flash until the battery unit 114 is fully charged. An arrangement multiple of LED battery indicator lights 136, as shown in FIG. 5, can indicate the power level of the internal battery unit 114 while charging. For example, one blinking LED battery indicator light 136 may indicate a charge of approximately 0%-25%, a first solid indicator light 136 and a second blinking indicator light 136 may indicate that the internal battery unit 114 has 26%-50% charge. Likewise, two solid indicator lights 136 and one blinking indicator light 136 would indicate 51%-75% charge, while three solid illuminated indicator lights 136 and one blinking indicator light 136 would indicate 76%-99% charge. Finally, four solidly lit lights 136 would represent 100% or a fully charged internal battery unit 114. In a similar manner, when the at least one electronic device 132 is being charged by the internal battery unit 114, the battery indicator lights may indicate the charge level of the at least on electronic device 132.

When not charging, the LED battery indicator light(s) 136 provide available charge information of the internal battery unit 114 by some or all of the LED battery indicator lights 136 being illuminated. For example, when the combination portable power charger and compact mirror unit 100 is detached or switched from receiving a charge from the external power source 130, the LED battery indicator lights 136 can indicate the charge level of the internal battery unit 114. One solid indicator light 136 would represent approximately 0%-25% charge, two solid indicator lights 136 would represent approximately 26%-50% charge, three solid indicator lights, an approximately 76%-99% charge. Finally, four solidly lit indicator lights 136 would represent 100% or a nearly fully charged internal battery unit 114.

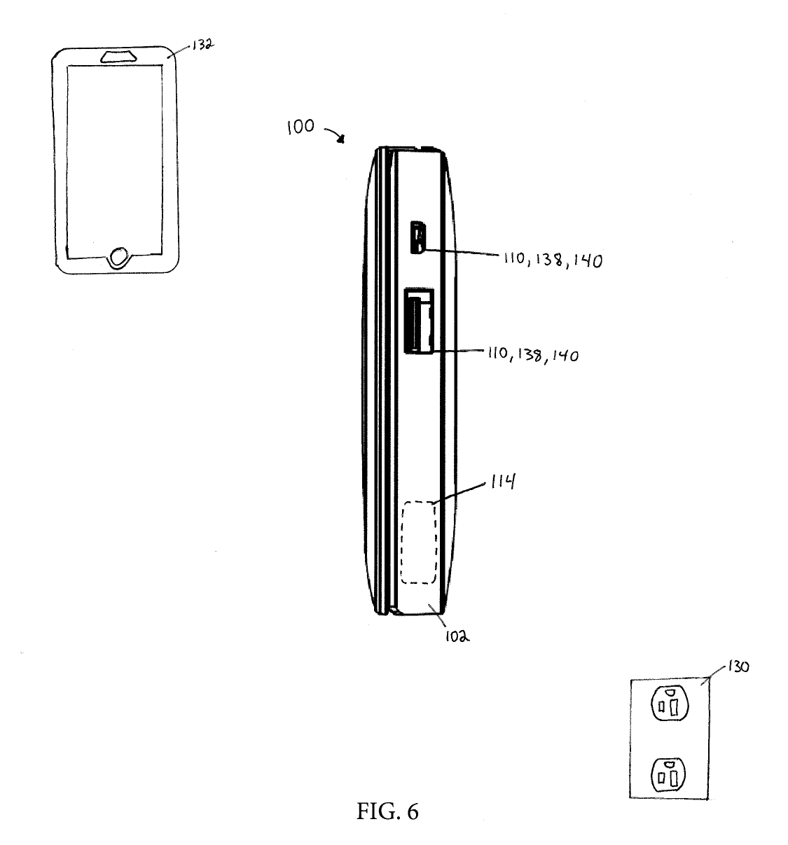

Referring to FIG. 6, a right-hand side view of the combination portable power charger and compact mirror unit 100 is shown with the cover 104 in a closed position. In this view, the location of the power connection ports 110 is illustrated.

In embodiments, the charger housing 102 has a dedicated power input connection port 138 for recharging the internal battery unit 114 when the charger is connected to the external power source 130, and a dedicated power output connection port 140 for recharging internal batteries of the electronic devices 132 connected to the charger housing 102. Either power connection port 110 is capable of being the dedicated power input connection port 138 or the dedicated power output connection port 140, in accordance with various embodiments. Alternatively, the ports can have the capability of acting as a power input or a power output depending on what the charger unit 100 is connected to, such as described and shown in co-pending U.S. application Ser. No. 13/682,985, which is incorporated herein by reference.

In an alternate embodiment of the present invention, the charger unit 100 can also include means for wireless charging. For example, a wireless transmitter may be disposed within the charger housing 102 for wirelessly recharging an electronic device having a complementary wireless receiver. In this regard, the charger unit 100 can recharge a wireless device when both are situated adjacent one another in a purse, bag or pocket, such as illustrated for example in U.S. Pat. No. 9,318,915 and co-pending U.S. application Ser. Nos. 14/934,511, 15/185,449 and 15/131,352, which are incorporated herein by reference. Similarly, the charger housing 102 can include a wireless receiver so that the internal battery unit 114 can be recharged using wireless charging means. In these designs, the wireless transmitter and wireless receiver would be operatively connected with the internal battery unit 114. In such embodiments, the charger housing can further include both wireless charging means as well as direct charging means via power connection female ports and power connection male interfaces to improve on the functionality of the charger 100.

Referring to FIG. 7, a perspective view of the combination portable power charger and compact mirror unit 100 with the cover 104 in an open position, in accordance with an embodiment of the present invention, is shown.

In embodiments, the cover 104 further includes a protruding edge 141 configured to close with a protruding edge 142 of the charger housing 102 while retaining an interior gap between the cover 104 and the charger housing so that a compact makeup insert 143 contained within the charger housing 102 does not contact the cover 104 or mirror 128. Accordingly, when the combination portable power charger and compact mirror unit 100 is in a closed position, the interior gap between the cover 104 and the charger housing 102 gradually diminishes from the notch 122 end to the hinge 120 end.

Referring to FIG. 8, the hinge 120 is shown in further detail by an inverted back side view of the combination portable power charger and compact mirror unit 100 with the cover 104 in a closed position. Specifically, the hinge 120 extends from the cover 104 into groves 144 formed within the charger housing 102. An axle 146 is disposed within the groves 144 to allow the hinge 120 and adhered cover 104 to pivot about the charger housing 102. In embodiments, the hinge 120 allows for the illumination of the light(s) 112 (not shown) by completing a circuit when the cover 104 is separated from the charger housing 102. When the cover 104 is in a closed position, the LED light(s) 112 shut off.

Referring to FIG. 9, a bottom view of the combination portable power charger and compact mirror unit 100 further includes a cut-away view showing a retractable charging cable 148 extending from the charger housing 102 in accordance with another embodiment of the present invention.

The charging cable 148 has a male connection interface can be used in lieu of or in addition to the power connection port(s) 110. The charging cable can be pivotally connected to the charger housing 102 or retractably connected to the charger housing 102. The charging cable 148 may additionally be storable within a storage cavity formed in the charger housing 102 with an opening formed in the side wall 106 or within the general footprint of the charger housing 102, from which it can be pulled for use connecting to the external power source 130 (shown in FIGS. 1 and 6), the at least one electronic device 132 (shown in FIGS. 1 and 6), or, using a connector cable 150 such as a split connector cable, both at the same time (as illustrated in FIG. 9). Specifically, a connector cord 158, connected to either the external power source 130 or the least one electronic device 132 is connected to the connector cable 150. Additionally, the charging cable 148 can be removable and replaced by interchangeable cables having varying connection interfaces to improve functionality and flexibility for the combination portable power charger and compact mirror unit 100. The connector cable 150 further includes a free end 152 for connecting to the external power source 130 or the at least one electronic device 132.

Referring to FIGS. 10 and 11, the combination portable power charger and compact mirror unit 100 may automatically turn on when connected with the at least one electronic device 132 that needs charging. More particularly, the combination portable power charger and compact mirror unit 100 detects the presence of the at least one electronic device 132 in connection with the power connection port 110 to draw power from the internal battery unit 114. Though not shown, a manual on/off button can be provided to control operation of the charging capabilities of the charger unit 100.

The combination portable power charger and compact mirror unit 100 of the present invention can also include operational logic, as controlled by the controller unit 116 and internal logic 154, that automatically turns the combination portable power charger and compact mirror unit 100 on and off for operation. In preferred embodiments, the combination portable power charger and compact mirror unit 100 turns on when the at least one electronic device 132 needing charging is connected via the power connection port 110 or the charging cable 148. As illustrated in FIG. 11, the portable power charger and compact mirror unit 100 includes an internal switch 156 disposed within the charger housing 102. In a preferred embodiment, the internal switch 156 actuates to an “on” position when the at least one electronic device 132 is connected via the power connection port 110.

More particularly, the combination portable power charger and compact mirror unit 100 (provided in Block 900) determines first if a cable (such as the connector cord 158 shown in FIG. 8) is plugged into the power connection port 110. Referring to FIG. 10, the activation process begins at Block 902 when something is plugged in to the power connection port 110. Next, at Block 904, the combination portable power charger and compact mirror unit 100 determines if there is something on the other end of the connector cord 158 drawing current from the combination portable power charger and compact mirror unit 100. For example, if the at least one electronic device 132 is connected, then the combination portable power charger and compact mirror unit 100 turns on (Block 906). In this situation, the combination portable power charger and compact mirror unit 100 may be in Power Output Mode. The combination portable power charger and compact mirror unit 100 will operate to recharge the electronic device 132 from the internal battery unit 114 via the connector cord 158 until the internal battery of the electronic device 132 is fully charged (Block 908).

If there is no electronic device drawing current from the combination portable power charger and compact mirror unit 100, the combination portable power charger and compact mirror unit 100 will then determine at Block 910 if there is something providing current—namely, the external power source 130, such as a wall socket, a car charger socket, an airplane charger socket, or a computer. For example, if the combination portable power charger and compact mirror unit 100 is connected to a wall socket, then the combination portable power charger and compact mirror unit 100 turns on (Block 912) so that the internal battery unit 114 can be recharged, if necessary. In this situation, the combination portable power charger and compact mirror unit 100 will turn on in Power Input Mode. The combination portable power charger and compact mirror unit 100 will first determine if the internal battery unit 114 is full (Block 914), and if not, the internal battery unit 114 will recharge until full capacity (Block 916), displaying its charging level via the battery indicator light(s) 136.

If the connector cord 158 is connected to the power connection port 110 but there is nothing connected at the other end of the connector cord 158—either the electronic device 132 to be charged or the external power source 130 that provides a current—then combination portable power charger and compact mirror unit 100 remains in a deactivated condition (Block 918).

A similar process is contemplated for the retractable charging cable 148 illustrated in FIG. 9, which may also act as a power output or power input connection, depending on what is connected to it.

Once the internal battery unit 114 and the battery of the at least one electronic 132 is fully charged, then the portable power charger and compact mirror unit 100 will shut off, preferably automatically, and more preferably after a preset time delay, such as indicated at Block 920 of FIG. 10.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A combination portable power charger and compact mirror comprising:
a charger housing internally storing a rechargeable battery;
a power connection interface operatively connected to the internal battery and capable of acting as a power input and a power output depending on what is connected to the power connection interface;
a cover pivotally connected to the charger housing and movable between a closed condition and an opened condition;
at least one LED light disposed in either the charger housing or the cover;
a first mirror recessed within a top surface of the charger housing for providing a reflective surface; and
a second mirror disposed on an inward facing surface of the cover such that the first mirror and the second mirror face one another when the cover is in its closed condition.

2. The combination portable power charger and compact mirror of claim 1, further comprising a charging cable operatively connected to the internal battery and retractably connected to the charger housing;
wherein the charging cable is storable within the general footprint of the charger housing.

3. The combination portable power charger and compact mirror of claim 1, wherein the at least one LED light automatically turns on when the cover is pivoted away from its closed condition towards its opened condition.

4. The combination portable power charger and compact mirror of claim 1, further comprising a switch disposed on the charger housing and operatively connected with the at least one LED light for manual operation thereof.

5. The combination portable power charger and compact mirror of claim 4, wherein the switch is a slideable dimmer switch allowing for independent adjustment of the brightness of the at least one LED light.

6. The combination portable power charger and compact mirror of claim 4, wherein the number of times the switch is depressed adjusts the brightness of the at least one LED light.

7. The combination portable power charger and compact mirror of claim 1, wherein one of the first and second mirrors is a distortion-free reflective surface and the other of the first and second mirrors is a magnification mirror.

8. The combination portable power charger and compact mirror according to claim 1, wherein the first mirror can be interchanged with a makeup insert.

9. The combination portable power charger and compact mirror according to claim 1, wherein a battery indicator means is provided on the charger housing to provide the charge capacity of the internal battery unit.

10. A combination portable power charger and compact mirror for recharging at least one electronic device having a rechargeable internal battery, said portable charger and compact mirror comprising:
a charger housing internally storing a rechargeable battery;
a power connection port operatively connected to the internal battery and capable of acting as at least one of (i) a power input for providing an electrical charge to the rechargeable battery when the portable charger and compact mirror is connected to an external power source, and (ii) a power output for charging an electronic device when said device is connected to the portable charger and compact mirror via the power connection port;
a cover pivotally connected to the charger housing and movable between a closed condition and an opened condition;
at least one LED light disposed in either the charger housing or the cover, wherein the at least one LED light automatically turns on when the cover is pivoted away from its closed condition; and
a first mirror disposed in one of an inward facing surface of the cover or the top surface of the charger housing for providing a reflective surface when the cover is in its opened condition.

11. The combination portable power charger and compact mirror of claim 10, further comprising:
a second mirror disposed on the other of the inward facing surface of the cover or the top surface of the charger housing away from the first mirror such that the first mirror and the second mirror face one another when the cover is in its closed condition.

12. The combination portable power charger and compact mirror of claim 11, wherein one of the first and second mirrors is a distortion-free reflective surface and the other of the first and second mirrors is a magnification mirror.

13. The combination portable power charger and compact mirror of claim 10, further comprising a switch disposed on the charger housing and operatively connected with the at least one LED light for manual operation thereof.

14. The combination portable power charger and compact mirror of claim 13, wherein the switch is a slideable dimmer switch allowing for independent adjustment of the brightness of the at least one LED light.

15. The combination portable power charger and compact mirror of claim 13, wherein the number of times the switch is depressed adjusts the brightness of the at least one LED light.

16. The combination portable power charger and compact mirror of claim 10, wherein the connection between the rechargeable battery and the power connection port automatically turns off after a preset time delay following the occurrence of one of the following shut-off conditions:
(i) wherein when the power connection port is connected to an external power source, the internal battery of the charger unit is fully charged;
(ii) wherein when the power connection port is connected to an electronic device, the internal battery of the at least one electronic device is fully charged; and
(iii) wherein when the power connection port is connected with an external power source and at least one electronic device at the same time, the internal battery of the charger unit and the internal battery of the at least one electronic device are fully charged.

17. The portable power charger and compact mirror unit of claim 11, further comprising:
a charging cable retractably connected to the charger housing and operatively connected to the internal battery,
wherein the charging cable is storable within the general footprint of the charger housing.

18. A combination portable power charger and compact mirror for recharging at least one electronic device having a rechargeable internal battery, said portable charger and compact mirror comprising:
a charger housing internally storing a rechargeable battery;
a power connection input port operatively connected to the internal battery for providing an electrical charge to the rechargeable battery when the portable charger and compact mirror is connected to an external power source;
a power connection output port operatively connected to the internal battery for charging an electronic device when said device is connected to the portable charger and compact mirror via the power connection output port;
a cover pivotally connected to the charger housing and movable between a closed condition and an opened condition;
at least one LED light disposed in either the charger housing or the cover, wherein the at least one LED light automatically turns on when the cover is pivoted away from its closed condition; and
a first mirror disposed in one of an inward facing surface of the cover or the top surface of the charger housing for providing a reflective surface when the cover is in its opened condition.

19. The combination portable power charger and compact mirror of claim 18, further comprising:
a second mirror disposed on the other of the inward facing surface of the cover or the top surface of the charger housing away from the first mirror such that the first mirror and the second mirror face one another when the cover is in its closed condition.

20. The combination portable power charger and compact mirror of claim 18, further comprising a switch disposed on the charger housing and operatively connected with the at least one LED light for manual operation thereof.

21. The combination portable power charger and compact mirror of claim 20, wherein the switch is a slideable dimmer switch allowing for independent adjustment of the brightness of the at least one LED light.

22. The combination portable power charger and compact mirror of claim 20, wherein the number of times the switch is depressed adjusts the brightness of the at least one LED light.

23. The portable power charger and compact mirror unit of claim 18, further comprising:
a charging cable retractably connected to the charger housing and operatively connected to the internal battery,
wherein the charging cable is storable within the general footprint of the charger housing.
